(19) United States
(12) Patent Application Publication
(10) Pub. No.: US 2026/0228350 A1
(43) Pub. Date: Aug. 6, 2026

(54) HA SESSION FAILOVER MECHANISM

(71) Applicant: Fortinet, Inc., Sunnyvale, CA (US)

(72) Inventors: Levana He, Burnaby (CA); Yong Wang, Burnaby (CA); Frank Pan, Burnaby (CA)

(73) Assignee: Fortinet, Inc., Sunnyvale, CA (US)

(21) Appl. No.: 19/042,126

(22) Filed: Jan. 31, 2025

(51) Int. Cl. G06F 21/60

(52) U.S. Cl. CPC G06F 21/606

(57) ABSTRACT

A system is disclosed. The system includes at least one physical memory device and one or more processors coupled with the at least one physical memory device to receive an interface status at a first network device from a second network device in a high availability (HA) cluster via a first HA interface, identify first sessions at the first network device that are owned by the second network device and update ownership of each session in the first sessions from the second network device to a third network device in the cluster, wherein the second network device comprises a secondary HA peer and the third network device comprises a primary HA peer.

### FIELD

Embodiments discussed generally relate to systems and methods to perform high availability (HA) session failover.

### BACKGROUND

HA interfaces are dedicated network interfaces used specifically for HA communication between two or more devices in a redundant system, thus enabling the devices to synchronize configurations and seamlessly failover to a backup device if one fails. However, conventional HA currently provide no failover mechanism for network traffic transferred from a secondary device to a primary device (e.g., transferred as part of a load balancing application) upon failure of the secondary device.

Hence, there exists a need in the art for enhanced systems and methods for to perform HA failover for network traffic that has been transferred from a secondary device to a primary device upon failure of the secondary device.

### SUMMARY

Various embodiments provide systems and methods for updating communication sessions in response to interface status changes at a network devices in a HA cluster.

This summary provides only a general outline of some embodiments. Many other objects, features, advantages, and other embodiments will become more fully apparent from the following detailed description, the appended claims and the accompanying drawings and figures.

### BRIEF DESCRIPTION OF THE DRAWINGS

A better understanding of the embodiments can be obtained from the following detailed description in conjunction with the following drawings, in which:

FIGS. 1A-1C illustrate embodiments of a network architecture including an interface monitor;

FIG. 2 illustrates one embodiment of a high availability cluster; and

FIG. 3 is a flow diagram illustrating one embodiment of an interface monitoring process.

### DETAILED DESCRIPTION

According to one embodiment, a mechanism is provided to update communication sessions in response to interface status changes at a network devices in a HA cluster.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or “a network security device” that may reside within the particular network that it is protecting, or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

As used herein, a “high availability (HA)” refers to a feature that provides redundancy to ensure network continuity in the event of a failure. An “HA interface” is used to maintain communication between HA peers to coordinate failover processes.

As used herein, a “traffic interface” refers to a network interface on a firewall appliance through which network traffic flows, and may refer to either ingress or egress traffic.

The phrase “HA cluster” as used herein refers to a group of two or more network devices that perform HA communication between in a redundant system, allowing the devices to synchronize configurations and seamlessly failover to a backup device if one fails, effectively eliminating single points of failure and ensuring continuous operation. Network devices in the cluster may be referred to as “HA peers”.

As “session” is used herein refers to a time-delimited two-way link, in the Internet protocol suite enabling interactive expression and information exchange between two or more devices.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

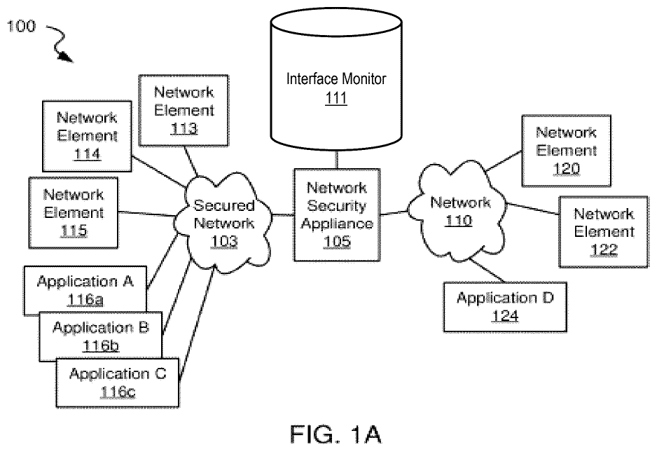

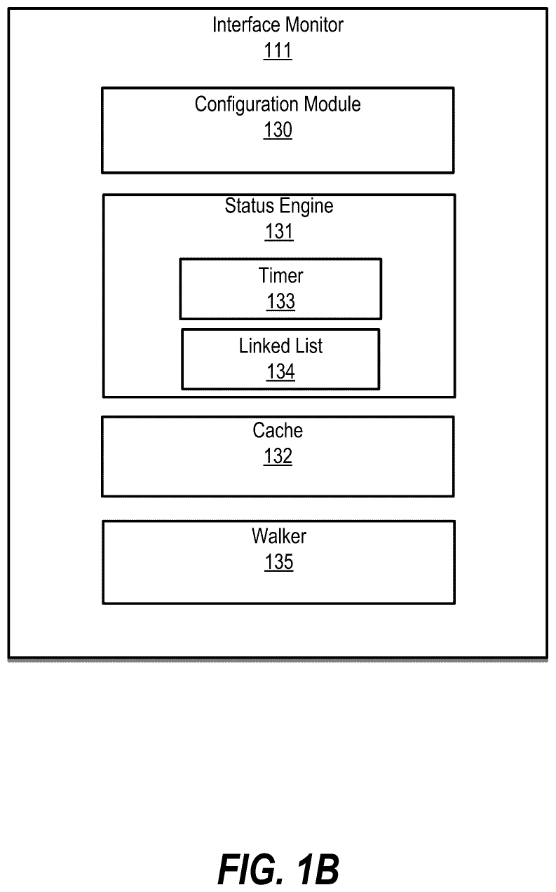

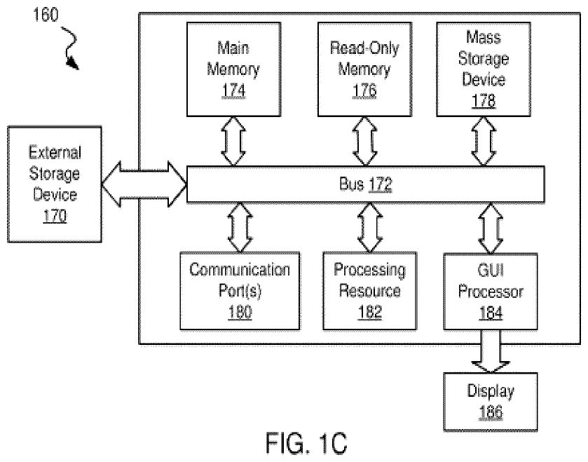

Turning to FIG. 1A, network architecture 100 is shown in accordance with some embodiments. In the context of network architecture 100, a network security appliance 105 controls access to network elements within a secured network 103. Secured network 103 may be any type of communication network known in the art. Those skilled in the art will appreciate that, secured network 103 can be a wireless network, a wired network, or a combination thereof that can be implemented as one of the various types of networks, such as an Intranet, a Local Area Network (LAN), a Wide Area Network (WAN), an Internet, and the like. Further, secured network 103 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

Secured network 103 provides for internetwork communications between network elements 113, 114, 115 and applications 116 (e.g., application A 116 A, application B 116 B, and application C 116 C). Network security appliance 105 operates as a gateway between secured network 103 and outside networks (e.g., a network 110). Network 110 may be any type of network known in the art. Thus, network 110 may be, but is not limited to, a wireless network, a wired network or a combination thereof that can be implemented as one of the various types of networks, such as the Internet, an Intranet, a Local Area Network (LAN), a Wide Area Network (WAN), and the like. Network security appliance 105 provides for communications between network element 113 and network element 120, network element 122, and network element 124 via network 110.

Network security appliance 105 executes an interface monitor 111 that is maintained on a computer readable medium communicably coupled to network security appliance 105. Execution of interface monitor 111 by network security appliance 105 enables a network security appliance 105 to monitor traffic interface status to ensure continuous traffic flow and exchanges with each peer in a HA cluster. In one embodiment, interface monitor 111 receives interface status update from HA peers, determines whether any interface status has changed (e.g., from “up” to “down”) and examines all sessions at the network security appliance 105 to determine network sessions associated with an HA peer having a changed status (e.g., failed HA peer). In a further embodiment, interface monitor 111 updates the ownership of the network sessions associated with the failed HA peer to a HA primary peer.

Although described above-as operating within network security appliance 105, other embodiments of interface monitor 111 may be implemented within any network element operating within network 100.

Turning to FIG. 1B, an embodiment of a interface monitor 111 is illustrated. As shown, interface monitor 111 includes configuration module 130, status engine 131, cache 132, linked list 134 and walker 135, which will be discussed in detail below.

Turning to FIG. 1C, an example computer system 160 is shown in which or with which embodiments of the present disclosure may be utilized. As shown in FIG. 1C, computer system 160 includes an external storage device 170, a bus 172, a main memory 174, a read-only memory 176, a mass storage device 178, one or more communication ports 180, one or more processing resources (e.g., processing circuitry 182), and a graphical user interface (GUI) processor 184. GUI processor 184 drives a display 186. In one embodiment, computer system 160 may represent some portion of any of network security appliance 105.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25 G, 40 G, and 100 G port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g., start-up or BIOS instructions for the processing resource.

Mass storage device 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such as front side bus (FSB), which connects processing resources to software systems.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 190 can be any kind of external hard-drives, floppy drives, IOMEGA® Zip Drives, Compact Disc—Read Only Memory (CD-ROM), Compact Disc—Rewritable (CD-RW), Digital Video Disk—Read Only Memory (DVD-ROM). Components described above are meant only to show various possibilities. In no way should the aforementioned example computer systems limit the scope of the present disclosure.

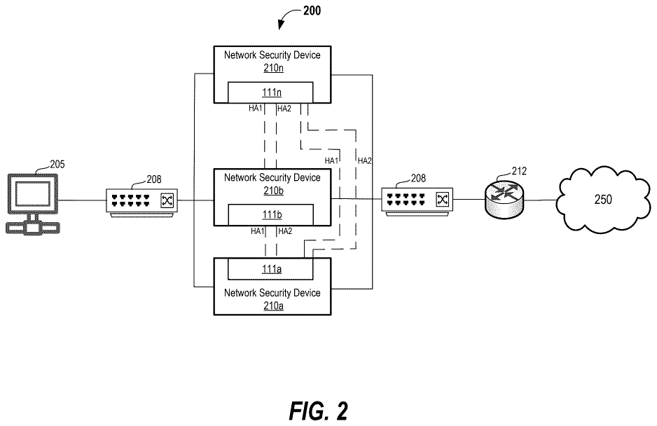

FIG. 2 illustrates one embodiment of a HA cluster 200. As shown in FIG. 2, HA cluster 200 includes network security devices 210 (e.g., 210a-210n) that operate as HA peers, and are coupled between an internal network 205 and a global network 250 (e.g., the Internet) via switches 208 and a router 212. In one embodiment, HA cluster 200 includes one primary HA peer 210 (e.g., network security device 210a), with the remaining HA peers 210 being secondary (e.g. network security devices 210b-210n). Each HA peer 210 is coupled to the other HA peers 210 via HA interfaces HA1 and HA2.

HA1 and HA2 interfaces comprise HA heartbeat interfaces. A HA heartbeat enables a HA peers 210 to communicate with each of the other HA peers. A heartbeat includes hello packets that are sent at regular intervals by the HA heartbeat interface of all HA peers 210. The hello packets describe the state of a HA peer 210 (e.g., including communication sessions) and are used by other HA peers 210 to maintain cluster 200 synchronization. While the cluster 200 is operating, the HA heartbeat confirms that all HA peers 210 are functioning normally.

According to one embodiment, each HA peer 210 includes an interface monitor 111 (e.g., 111a-111n) that is configured to monitor traffic interfaces (e.g., ingress and egress) at the respective HA peer 210. In such an embodiment, an interface monitor 111 detects a traffic interface down event in order to trigger a HA failover, which results in network sessions associated with the failed HA peer 210 being resumed at a new primary HA peer. However, in load balancing applications, network sessions may be load balanced to one or more secondary HA peers. In such applications, there is currently no mechanism to failover sessions load balanced to the secondary HA peer to other HA peers upon the secondary HA peer becoming unhealthy (e.g., failing).

According to one embodiment, each interface monitor 111 comprises a mechanism to enable each secondary HA peer 210 to monitor the traffic interface status with HA peers 210 in cluster 200 and to failover sessions associated with the secondary HA peer 210 to the primary HA peer. In such an embodiment, an interface monitor 111 at an HA peer 210 (e.g. primary and secondary devices) receives a status from a secondary HA peer 210 via an HA interface and determines whether the traffic interface status has changed (e.g., from “up” to “down”). Subsequently, all sessions at the HA peer 210 examines all sessions to determine whether it includes any sessions associated with the unhealthy secondary HA peer 210. Interface monitor 111 updates a session's owner to be the primary HA peer 210 for each session (e.g., ingress or egress interface) associated with the unhealthy secondary HA peer 210. In a further embodiment, this process occurs at each HA peer (e.g. primary and secondary HA peers 210) in cluster 200.

Referring back to FIG. 1B, configuration module 130 is implemented to configure HA settings. In one embodiment, the HA settings may be configured to enable failover for sessions that have been load balanced to secondary HA peers 210. In this embodiment, the secondary failover may be enabled via a secondary health setting (e.g., set check-secondary-dev-health enable).

Status engine 131 monitors the traffic interface status of HA peers 210 in cluster 200 once the secondary health setting is enabled. In embodiments, status engine 131 comprises a daemon dedicated to monitoring the interface status, and exchanges the status of each secondary interface with other HA peers. Status engine 131 receives interface status updates from secondary HA peers and determines whether any interface status has changed (e.g., from “up” to “down”), thus indicating a possibly unhealthy secondary HA peer 210.

Status engine 131 includes a timer 133 to avoid issues caused by interface flapping (e.g., caused by a physical interface continuously changing between “up” to “down”) by delaying actions for a predetermined time threshold until there is a determination that an interface status change is stable. In one embodiment, status engine 131 adds an interface to linked list 134 upon a determination that the interface is down (or down interface). Further, status engine 131 triggers a system call to generate a dedicated session walker once it is determined that the interface has been down for a predetermined time set at timer 133. Linked list 134 keeps track of interfaces that have changed status. In one embodiment, linked list 134 tracks interfaces that have changed from ‘up’ to ‘down’ by comparing the current status with a previous status stored in the cache 132. When such a change is detected, the interface is added to linked list 134.

Walker 135 generates the dedicated session walker that is implemented to identify and update the owner of sessions associated with the down interface (or affected sessions) (e.g., sessions owned by the unhealthy secondary HA peer). According to one embodiment, walker 135 generates a dedicated session walker in response to the system call. In such an embodiment, the system call includes a physical index associated with the failed interface and the owner identifier (ID) of the unhealthy secondary HA peer. Walker 135 updates the owner of each session based on the physical index and the owner ID.

In a further embodiment, walker 135 performs a check of three arguments: ha_generation, ha_id, and physical index of the failed interface. The ha_generation value monitors the version of virtual cluster update as the session walker operates asynchronously. Further, the version is tracked to maintain consistency since the virtual cluster state may change during the life of the session walker. The virtual cluster update version (ha_generation) tracks the version of the virtual cluster's state. Since the session walker operates asynchronously, the virtual cluster state may change during its execution. The ha_generation value ensures that ownership updates are based on the most current cluster state, maintaining consistency throughout the process. Therefore, tracking the version is essential to ensure accurate and consistent ownership updates.

The ha_id is the ID to identify the unhealthy secondary HA peer, and is used together with the failed interface index to search for all the affected sessions, and update the sessions' owner accordingly. In one embodiment, walker 135 identifies all sessions associated with the ha_id and failed interface, updates the sessions' owner to be the primary HA peer 210. In one embodiment, the sessions' owner is updated by changing the owner ID from the ha_id associated with the unhealthy secondary HA peer 210 to an ha_id associated with the primary HA peer 210.

Walker 135 also performs one or more cleanup tasks (e.g., conduct context cleanup). One such cleanup task is to remove corresponding network processing unit (NPU) sessions to enable network traffic to be properly offloaded again on the primary HA peer 210 to avoid potential packet loss.

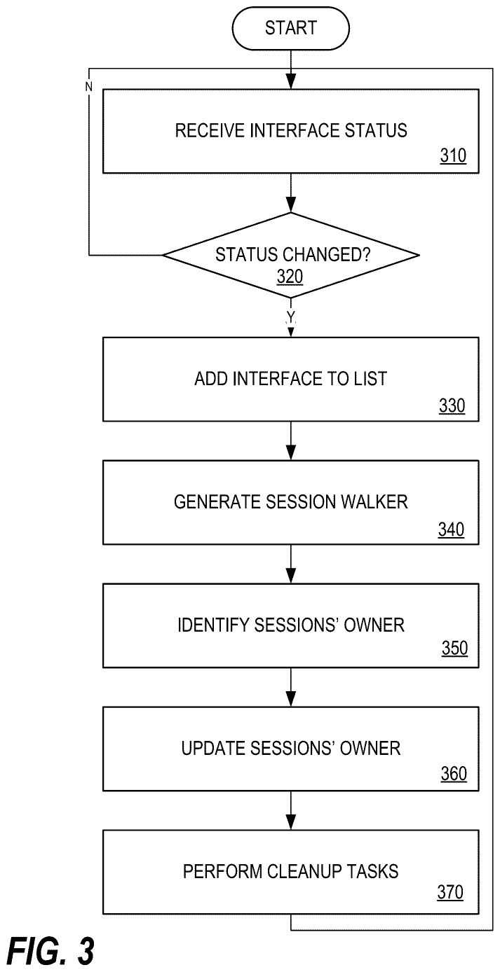

FIG. 3 is a flow diagram illustrating one embodiment of an interface monitoring process at a HA peer. At processing block 310, an interface status is received at the HA peer (e.g., primary or secondary device) in a HA cluster from a secondary HA peer. At decision block 320, a determination is made as to whether the interface has changed. If not, control is returned to processing block 310, where a subsequent interface status is received. Otherwise the interface is added to a linked list, processing block 330. As discussed above, the interface is added to the list in order to delay any action until the interface status change is determined to be stable after a predetermined time threshold.

At processing block 340, a dedicated session walker is generated based on the triggering of a system call. At processing block 350, the walker identifies all sessions associated with the failed interface and owned by the unhealthy secondary HA peer. At processing block 360, the walker updates the sessions' owner to be the primary HA peer. At processing block 370, the walker performs one or more cleanup tasks.

The above-described process ensures that sessions are effectively managed and updated in response to interface status changes at a secondary network devices in a HA cluster, thus maintaining network reliability and continuity.

Thus, it will be appreciated by those of ordinary skill in the art that the diagrams, schematics, illustrations, and the like represent conceptual views or processes illustrating systems and methods. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing described embodiments. Those of ordinary skill in the art further understand that the exemplary hardware, software, processes, methods, and/or operating systems described herein are for illustrative purposes and, thus, are not intended to be limited to any particular named.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments, other and further embodiments may be devised without departing from the basic scope thereof. The scope of the embodiments is determined by the claims that follow. The embodiments are not limited to the described embodiments, versions or examples, which are included to enable a person having ordinary skill in the art to make and use the embodiments when combined with information and knowledge available to the person having ordinary skill in the art.

What is claimed is:

1. A system comprising:
at least one physical memory device; and
one or more processors coupled with the at least one physical memory device to:
receive an interface status at a first network security device from a second network security device in a high availability (HA) cluster via a HA interface;
identify first sessions at the first network security device that are owned by the second network security device; and
update ownership of each session in the first sessions from the second network security device to a third network security device in the cluster, wherein the second network security device comprises a secondary HA peer and the third network security device comprises a primary HA peer.

2. The system of claim 1, wherein the one or more processors further to determine whether the status of traffic interface has changed.

3. The system of claim 2, wherein determining whether the status of the traffic interface has changed comprises comparing a current status to a previously stored status.

4. The system of claim 2, wherein the one or more processors further to add the traffic interface to a linked list upon determining that the status change is not caused by interface flapping.

5. The system of claim 4, wherein the one or more processors further to generate a session walker to identify an owner of the first sessions and update the ownership of the first sessions.

6. The system of claim 5, wherein the session walker is generated in response to a system call.

7. The system of claim 6, wherein the system call comprises a physical index associated with the traffic interface and an owner identifier (ID) of the second network security device.

8. The system of claim 7, wherein updating the ownership of the first sessions comprises changing the owner ID from the second device to the third network security device.

9. The system of claim 5, wherein the one or more processors further to perform one or more cleanup tasks.

10. The system of claim 1, wherein the one or more processors further to
receive a second interface status at a fourth network security device in the HA cluster from the second network security device via a second HA interface;
identify second sessions at the fourth network security device that are owned by the second network security device; and
update ownership of the second sessions from the second network security device to the third network security device, wherein the fourth network security device comprises a secondary HA peer.

11. A method comprising:
receiving an interface status at a first network security device from a second network security device in a high availability (HA) cluster;
identifying first sessions at the first network security device that are owned by the second network security device; and
updating ownership of each session in the first sessions from the second network security device to a third network security device in the cluster, wherein the second network security device comprises a secondary HA peer and the third network security device comprises a primary HA peer.

12. The method of claim 11, further comprising determining whether the status of a traffic interface has changed.

13. The method of claim 12, wherein determining whether the status of the traffic interface has changed comprises comparing a current status to a previously stored status.

14. The method of claim 12, further comprising:
adding the traffic interface to a linked list upon determining that the traffic interface has changed;
generating a session walker to identify an owner of the first sessions; and
updating the ownership of the first sessions.

15. The method of claim 14, wherein updating the ownership of the first sessions comprises changing an owner identifier (ID) from a second device to the third network security device.

16. At least one non-transitory computer readable medium having instructions stored thereon, which when executed by one or more processors, cause the processors to:
receive an interface status at a first network security device from a second network security device in a high availability (HA) cluster via a first HA interface;
identify first sessions at the first network security device that are owned by the second network security device; and
update ownership of each session in the first sessions from the second network security device to a third network security device in the cluster, wherein the second network security device comprises a secondary HA peer and the third network security device comprises a primary HA peer.

17. The computer readable medium of claim 16, having instructions stored thereon, which when executed by one or more processors, further cause the processors to determine whether the status of a traffic interface has changed.

18. The computer readable medium of claim 17, wherein determining whether the status of the traffic interface has changed comprises comparing a current status to a previously stored status.

19. The computer readable medium of claim 17, having instructions stored thereon, which when executed by one or more processors, further cause the processors to:
add the traffic interface to a linked list upon determining that the traffic interface has changed;
generate a session walker to identify an owner of the first sessions; and
update the ownership of the first sessions based on the linked list.

20. The computer readable medium of claim 19, wherein updating the ownership of the first sessions comprises changing an owner identifier (ID) from a second device to the third network security device.
